(19) United States
(12) Patent Application Publication
(10) Pub. No.: US 2026/0186209 A1
(43) Pub. Date: Jul. 2, 2026

(54) PHOTONIC INTEGRATED CIRCUIT WITH A PLUGGABLE FIBER COUPLER

(71) Applicant: Lightmatter, Inc., Boston, MA (US)

(72) Inventors: Omkar Karhade, Chandler, AZ (US); Shashank Gupta, Gurugram (IN)

(73) Assignee: Lightmatter, Inc., Boston, MA (US)

(21) Appl. No.: 19/431,155

(22) Filed: Dec. 23, 2025

Related U.S. Application Data
(60) Provisional application No. 63/739,459, filed on Dec. 27, 2024.

(51) Int. Cl. G02B 6/30; G02B 6/32; G02B 6/42

(52) U.S. Cl. CPC G02B 6/305; G02B 6/32; G02B 6/4212

(57) ABSTRACT

Described herein are systems and techniques for providing photonic devices having efficient optical coupling between waveguides and optical fibers. The photonic devices comprise an edge coupler disposed within a cavity of a photonic integrated circuit (PIC) and a pluggable assembly removably coupled with the edge coupler. The PIC includes a spot size converter optically coupled to a waveguide to expand light received from the waveguide prior to exiting the PIC.

### CROSS-REFERENCE TO RELATED APPLICATIONS

This application claims the benefit of U.S. Provisional Application Ser. No. 63/739,459, filed on Dec. 27, 2024, under Attorney Docket No. L0858.70113US00 and entitled “PHOTONIC INTEGRATED CIRCUIT WITH A PLUGGABLE FIBER COUPLER,” which is hereby incorporated herein by reference in its entirety.

### BACKGROUND

Optical interconnects are a type of communication technology employed by optical communication systems that use light signals to transmit data between different components or devices within the system. Optical communication systems employ various optical components to transmit an optical signal throughout the network. Optical communication systems thus benefit from efficient, low-loss coupling mechanisms at the optical interconnects.

### BRIEF SUMMARY

The inventors have developed the devices and techniques described herein to provide low-loss coupling mechanisms for the optical interconnects of an optical communication system. Some optical interconnects employ edge coupling mechanisms to optically couple an optical fiber to a photonic device (e.g., a photonic integrated circuit (PIC)). However, edge coupling can exhibit higher loss than other coupling mechanisms due to mode size mismatch between the optical fiber and the waveguides on the PIC and the active alignment typically used to ensure efficient optical coupling. Accordingly, the systems and techniques described herein provide for efficient edge coupling mechanisms that address mode size mismatch while maintaining high coupling efficiency, broad bandwidth, and relaxed alignment tolerances.

In some aspects, the techniques described herein relate to a photonic device, including: a photonic integrated circuit (PIC) having a waveguide and a membrane including a spot size converter (SSC) optically coupled to the waveguide, wherein the PIC defines a cavity positioned at an edge of the PIC; an edge coupler disposed at least partially in the cavity of the PIC; and a pluggable assembly including a fiber array unit (FAU) and a fiber attached to the FAU, wherein the FAU is attached to the edge coupler, and wherein the edge coupler defines an optical path optically coupling the SSC to the fiber.

In some aspects, the techniques described herein relate to a photonic device, wherein the edge coupler includes a first lens configured to collimate light emitted by the SSC.

In some aspects, the techniques described herein relate to a photonic device, wherein the pluggable assembly includes a second lens configured to focus the light collimated by the first lens to the fiber.

In some aspects, the techniques described herein relate to a photonic device, wherein the first lens is configured to collimate the light emitted by the SSC to a mode field diameter (MFD) between 20 μm and 30 μm.

In some aspects, the techniques described herein relate to a photonic device, wherein the SSC is configured to spatially expand light received from the waveguide to a first MFD between 5 μm and 15 μm as the light exits the PIC.

In some aspects, the techniques described herein relate to a photonic device, wherein the edge coupler is configured to further spatially expand the light from the first MFD to a second MFD between 20 μm and 30 μm as the light exits the edge coupler.

In some aspects, the techniques described herein relate to a photonic device, further including an index matching epoxy (IME) disposed between a substrate of the PIC and the membrane.

In some aspects, the techniques described herein relate to a photonic device, wherein the IME extends in the cavity between the substrate of the PIC and the edge coupler.

In some aspects, the techniques described herein relate to a photonic device, including: a photonic integrated circuit (PIC) having a waveguide optically coupled with a spot-size converter (SSC), wherein the PIC defines a cavity positioned at an edge of the PIC; an edge coupler disposed at least partially in the cavity of the PIC, the edge coupler including a first lens configured to collimate light emitted by the SSC; and a pluggable assembly including a fiber array unit (FAU) and a fiber attached to the FAU, wherein the FAU is attached to the edge coupler, and wherein the edge coupler defines an optical path optically coupling the SSC to the fiber.

In some aspects, the techniques described herein relate to a photonic device, wherein the pluggable assembly includes a second lens configured to focus the light collimated by the first lens on the fiber.

In some aspects, the techniques described herein relate to a photonic device, further including an undercut extending from the cavity on an interior side of the SSC.

In some aspects, the techniques described herein relate to a photonic device, further including an IME disposed in the cavity between the substrate of the PIC and the waveguide.

In some aspects, the techniques described herein relate to a photonic device, wherein the IME extends in the cavity between the substrate of the PIC and the edge coupler.

In some aspects, the techniques described herein relate to a photonic device, wherein the SSC is configured to spatially expand light received from the waveguide to a first mode field diameter between 5 μm and 15 μm as the light exits the PIC.

In some aspects, the techniques described herein relate to a photonic device, wherein the edge coupler is configured to further spatially expand the light from a first mode field diameter to a second mode field diameter between 20 μm and 30 μm as the light exits the edge coupler.

In some aspects, the techniques described herein relate to a method of manufacturing a photonic device, the method including: obtaining a photonic integrated circuit (PIC) having a waveguide optically coupled with an SSC; etching a portion of a substrate of the PIC to define a cavity at an edge of the PIC; placing an edge coupler in the cavity, the edge coupler having a first lens configured to collimate light received from the waveguide; and removably attaching a pluggable assembly, including an FAU and a fiber attached to the FAU to the edge coupler, to the edge coupler, so that the edge coupler defines an optical path optically coupling the SSC to the fiber.

In some aspects, the techniques described herein relate to a method, further including, prior to placing the edge coupler in the cavity, forming a membrane including the SSC by etching a portion of the substrate from the cavity to an interior of the PIC in correspondence with the SSC.

In some aspects, the techniques described herein relate to a method, further including filling a volume between the substrate and the membrane.

In some aspects, the techniques described herein relate to a method, further including, prior to placing the edge coupler in the cavity, disposing IME in the cavity and wherein: placing the edge coupler in the cavity includes placing the edge coupler so it abuts the IME in the cavity.

In some aspects, the techniques described herein relate to a method, wherein removably attaching the pluggable assembly to the edge coupler includes mating alignment features in the pluggable assembly with alignment features in the edge coupler.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same or similar reference number in the figures in which they appear. In the figures:

FIG. 1A illustrates an example photonic device, according to some embodiments;

FIG. 1B illustrates an example spatial profile of light propagating through the photonic device of FIG. 1A, according to some embodiments;

FIG. 2 illustrates an example photonic package comprising the photonic device of FIG. 1A, according to some embodiments;

FIG. 3 illustrates another example photonic package comprising the photonic device of FIG. 1A, according to some embodiments;

FIG. 4A illustrates an example photonic integrated circuit (PIC) that may be used to manufacture a photonic device, according to some embodiments;

FIG. 4B illustrates the PIC of FIG. 4A having been etched to define a cavity, according to some embodiments;

FIG. 4C illustrates the PIC of FIG. 4A having been further etched to form a membrane extending towards the cavity, according to some embodiments;

FIG. 4D illustrates the PIC of FIG. 4A further having index matching epoxy (IME) disposed in the cavity and an edge coupler placed in the cavity, according to some embodiments; and

FIG. 4E illustrates the PIC of FIG. 4A further having a pluggable assembly removably attached to the edge coupler, according to some embodiments.

### DETAILED DESCRIPTION

Optical communication systems that utilize light signals to transmit data between different components or devices in the system utilize various optical components to transmit the signals. For example, light signals may be transmitted through waveguides on various substrates, including photonic integrated circuits (PICs), and optical fibers. The inventors have recognized and appreciated that optical communication systems benefit from low-loss coupling mechanisms to maintain the quality of the light signal during transmission through the different components.

The inventors have further recognized and appreciated that conventional solutions for coupling PICs suffer from poor alignment tolerance, high insertion loss, and limited bandwidth. Grating couplers, for example, offer high coupling efficiency but have a narrow spectral bandwidth and are not compatible with certain photonic device packaging form factors.

Conventional v-groove based solutions lack pluggability, preventing easy replacement of non-functioning fiber attachments. Other solutions require very high alignment accuracy between the PIC and the coupler, typically less than 0.2-0.5 μm. Such high alignment accuracy is challenging to achieve and results in slow and expensive processing. Edge coupling provides a wider bandwidth and more compatibility with standard form factors than other coupling mechanisms. However, edge couplers may exhibit higher insertion loss due to mode size mismatch between the optical fiber and PIC waveguide. Active alignment techniques are often utilized to improve optical alignment, but these techniques are costly and time-consuming, thus hindering mass production and scalability.

Accordingly, the inventors have developed the systems and techniques described herein that employ an optical coupling mechanism that can accommodate mode size mismatch between the PIC waveguides and optical fibers, while maintaining high coupling efficiency, broad bandwidth, and relaxed alignment tolerances. Some embodiments utilize an edge coupler that expands the light coming out of the PIC, collimates the light, and/or reroutes it using optical components such as mirrors, lenses, and reflectors to expand light to a larger mode field diameter (MFD). Some embodiments utilize a pluggable and replaceable fiber attachment mechanism that enables easy maintenance and repair and enhances the practicality and scalability of the optical interconnect system.

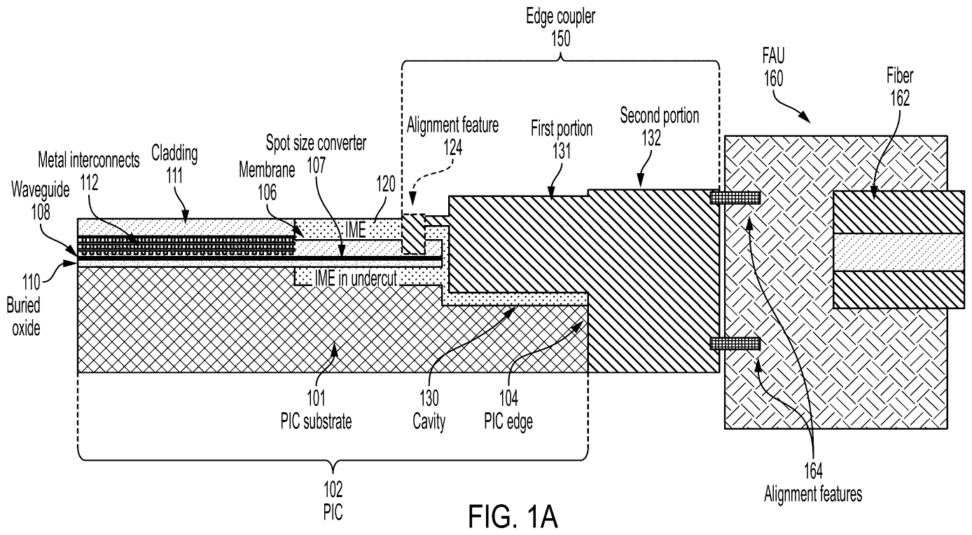

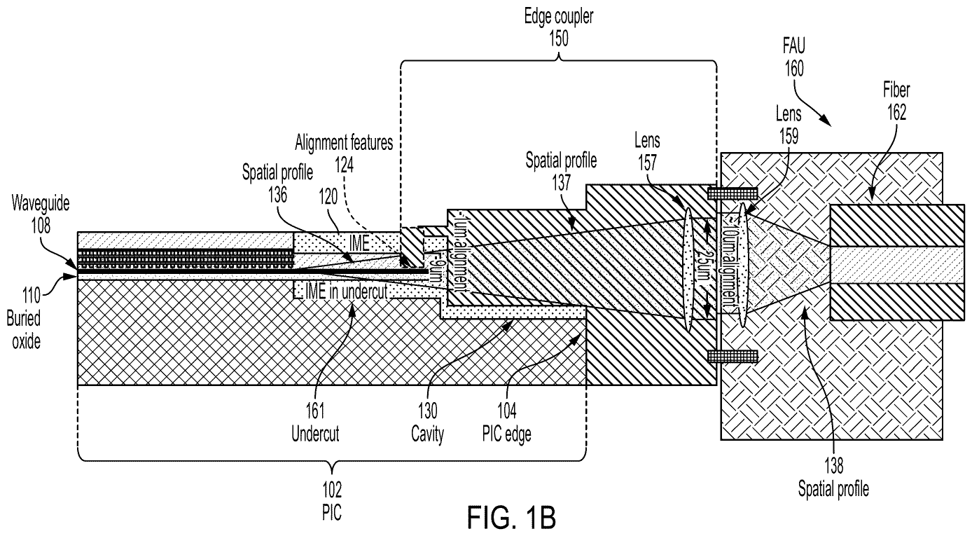

FIG. 1A illustrates an example photonic device, according to some embodiments. In the illustrated embodiment, the photonic device includes PIC 102, edge coupler 150, and a pluggable assembly. In some embodiments, the pluggable assembly comprises a fiber array unit (FAU) 160 and a fiber 162. FIG. 1B illustrates an example spatial profile of light propagating through the photonic device of FIG. 1A, according to some embodiments.

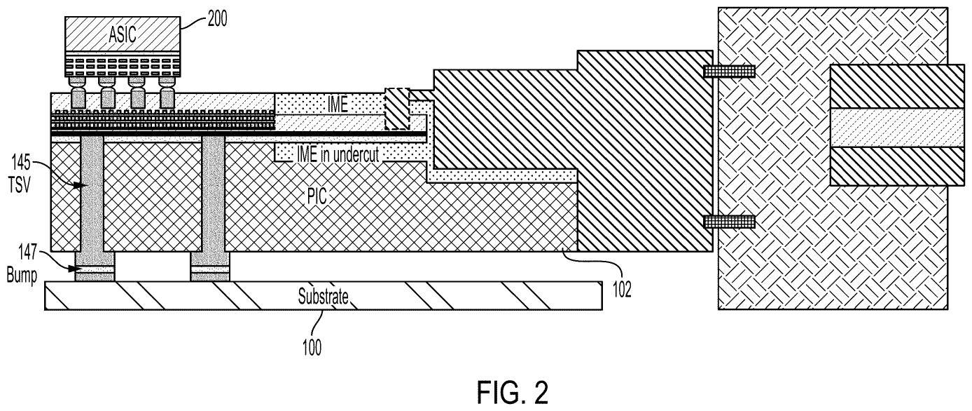

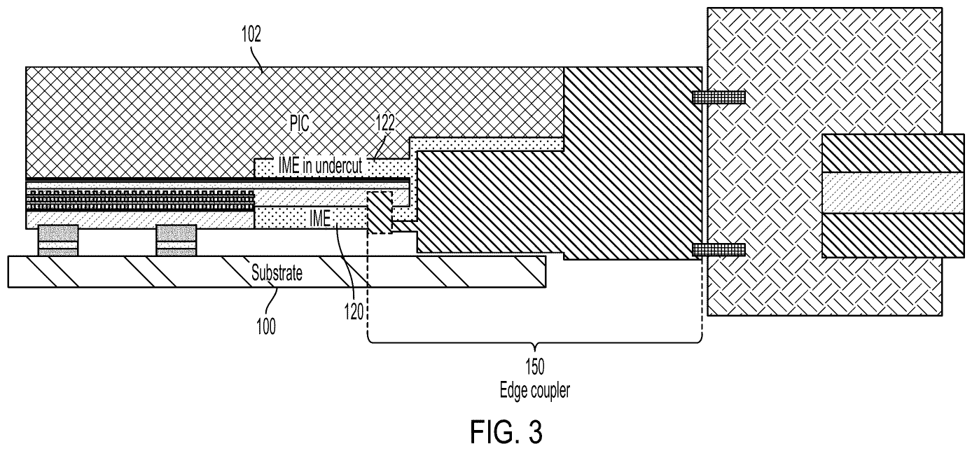

In the illustrated embodiment, PIC 102 includes PIC substrate 101, waveguide 108, metal interconnects 112, and cladding 111. In some embodiments, PIC 102 further includes a buried oxide layer 110. Cladding 111 serves as the upper cladding while buried oxide layer 110 serves as the lower cladding, enabling tight mode confinement within waveguide 108. Cladding 111 may be further configured to provide physical, electrical, and optical protection to the various components disposed on PIC 102. Cladding 111 and buried oxide layer 110 may be made of any suitable material, including for example, silicon oxide. As discussed further with respect to FIGS. 2 and 3, metal interconnects 112 may comprise metal traces, pads, through-silicon vias (TSVs) or other metal interconnects for electrically connecting components on and external to PIC 102.

As noted above, edge coupling may exhibit losses attributable to mode size mismatch. Accordingly, PIC 102 may further include spot size converter (SSC) 107 configured to expand the optical mode of light received from waveguide 108. SSC 107 is optically coupled to waveguide 108 and extends to an edge of cavity 130 so that a coupling interface of SSC 107 is exposed to cavity 130 for coupling with edge coupler 150. In some embodiments, SSC 107 comprises a tapered portion of waveguide 108, the taper getting narrower as SSC 107 approaches cavity 130.

As shown in FIG. 1B, as light propagates from waveguide 108 through SSC 107, the spatial profile 136 of the optical mode of the light expands as it approaches cavity 130. In some embodiments, SSC 107 is configured to expand the optical mode of the light to a first mode field diameter (MFD) as it approaches cavity 130. In some embodiments, the first MFD is between 5-15 μm, 5-10 μm, or approximately 10 μm. In some embodiments, the first MFD is approximately 9 μm.

Cavity 130 may be etched partially through PIC 102 (e.g., from cladding 111 partially through PIC substrate 101 in the illustrated embodiment). Cavity 130 is configured to facilitate coupling between PIC 102 and edge coupler 150. As such, cavity 130 may be etched into PIC 102 such that, when edge coupler 150 is placed within cavity 130, waveguide 108 (e.g., via SSC 107) is optically coupled with the optical components of edge coupler 150. Cavity 130 may be formed in any suitable manner, including dry etching, wet etching, or anisotropic etching. In some embodiments, PIC 102 may be obtained from an external foundry having cavity 130 already formed. To secure edge coupler 150 within cavity 130, in some embodiments, adhesive (e.g., epoxy) may be disposed within cavity 130. After placement of edge coupler 150 within cavity 130, the adhesive may be cured (e.g., ultraviolet (UV) cured) to secure edge coupler within cavity 130.

In some embodiments, to further mitigate optical losses attributable to edge coupling of SSC 107 with edge coupler 150, PIC 102 may be further etched to form a membrane 106. Membrane 106 may comprise at least a portion of SSC 107 extending towards cavity 130. For example, an undercut 161 on the interior side of SSC 107 may be formed extending from cavity 130 along SSC 107. The volume of the undercut may thus be defined by membrane 106 and PIC substrate 101. In some embodiments, undercut 161 extends along an entire length of SSC 107. In that way, SSC 107 may be used as a guide during formation of undercut 161.

In some embodiments, undercut 161 is configured to facilitate expansion of the optical mode of light from waveguide 108 and reduce optical losses attributable to the coupling interface between SSC 107 and edge coupler 150. In some embodiments, the volume of undercut 161 may be filled with index-matching fluid (e.g., index-matching epoxy) and subsequently cured (e.g., UV cured). In some embodiments, the entire volume of undercut 161 defined between PIC substrate 101 and membrane 106 may be filled. Additionally, in some embodiments, index-matching epoxy 120 is disposed on the other side of membrane 106 than undercut 161 (e.g., the side facing outwards from PIC 102). In that way, index matching epoxy 120 may be disposed on all sides of membrane 106 so as to surround membrane 106 with the epoxy.

The index-matching fluid may facilitate expansion of the optical mode of light by containing the expanding light within membrane 106 prior to exiting PIC 102 and enteringoptical coupler 150. In some embodiments, the same index-matching epoxy may be used to fill undercut 161 and cavity 130. The index-matching fluid may have a refractive index between that of the SSC 107 and optical components of edge coupler 150. In some embodiments, the index-matching fluid has a refractive index between 1.50 and 1.57.

Edge coupler 150 is coupled to PIC 102 within cavity 130 of PIC 102. Accordingly, edge coupler 150 may have a corresponding shape to cavity 130. In the illustrated embodiment, edge coupler 150 has a first portion 131 that sits within cavity 130 and a second portion 132 that extends beyond PIC 102. In some embodiments, the second portion 132 is configured to abut PIC edge 104 to align the optical components of edge coupler 150 with SSC 107 along a first axis (e.g., the horizontal direction as illustrated). In that way, the gap between SSC 107 and the first portion 131 can be minimized by using second portion 132 as a reference. Reducing the gap mitigates losses attributable light propagating across the SSC-coupler interface.

In some embodiments, to align the optical components of edge coupler 150 with SSC 107 along a second axis (e.g., the vertical direction as illustrated), edge coupler 150 and PIC 102 may include alignment features 124. Alignment features 124 may be configured to align the optical components with SSC 107 by referencing known surfaces (e.g., membrane 106 or a surface of first portion 131) of PIC 102 and/or edge coupler 150. In some embodiments, alignment features 124 are configured to align the optical components with SSC 107 to an alignment accuracy (e.g., maximum offset) of approximately ±1.5 μm or less. In the illustrated embodiment, alignment features 124 comprise an alignment arm of edge coupler 150 and a corresponding alignment recess disposed in PIC 102 (e.g., in membrane 106). In other embodiments, PIC 102 may include an alignment arm and optical coupler 150 may include a corresponding recess. Other alignment feature types may be used in addition to or alternatively to the arm and corresponding recess. For example, the alignment features may comprise pins extending between edge coupler 150 and PIC substrate 101 that may be positioned in various regions (e.g., cavity 130, PIC edge 104) of the photonic device. Further, although only one pair of alignment features is illustrated, it can be appreciated that more pairs may be present.

Edge coupler 150 may act as an optical bridge between PIC 102 and fiber 162. Accordingly, edge coupler 150 includes one or more optical coupling components (e.g., waveguides, lenses) to optically couple waveguide 108 with fiber 162. To further address the aforementioned mode size mismatch present in conventional edge coupling, in some embodiments, edge coupler 150 includes an SSC. The SSC may be configured as a tapered waveguide that narrows as it extends through edge coupler 150 away from PIC 102. In some embodiments, the SSC of edge coupler 150 may be configured to expand the diameter of the light from the first MFD (e.g., as output by SSC 107) to a second MFD. As illustrated in FIG. 1B, spatial profile 137 may continue from spatial profile 136 and continues to expand as it extends through coupler 150. In some embodiments, the second MFD is between 20-30 μm. In some embodiments, the second MFD is 25 μm.

Not all embodiments include waveguides within edge coupler 150. In some embodiments, for example, mode expansion from the first MFD to the second MFD occurs via free space propagation (within the edge coupler 150). Optionally, one or more lenses may be used to enhance the mode expansion as light travels within edge coupler 150.

As the expansion of the light through edge coupler 150 may cause the light to diverge, in some embodiments, edge coupler 150 includes lens 157. Lens 157 may be configured to collimate the diverging light emitted by SSC 107 so that the rays of the light diverge less before exiting edge coupler 150. While collimation is generally referred to as the effect by which a device takes divergent or convergent optical rays and makes them parallel, it should be appreciated that, as used herein, “collimation” should be interpreted more broadly to include scenarios in which a beam's angle of divergence (or convergence) is reduced. In other words, light output by a collimator (e.g., collimating lens) needs not be perfectly parallel, but may be quasi-parallel. In one example, a collimator may take a beam having an angle of divergence of approximately 10° and may output a beam having an angle of divergence of approximately 3°. In another example, a collimator may take a beam having an angle of divergence of approximately 10° and may output a beam having an angle of convergence of approximately 3°.

The pluggable assembly is coupled with edge coupler 150 to optically couple fiber 162 to waveguide 108. The pluggable assembly may include a fiber array unit (FAU) 160 at a terminal end of fiber 162. In some embodiments, the pluggable assembly is configured to be removably coupled to edge coupler 150 through FAU 160. In that way, defective components of an optical communication system can be easily replaced. FAU 160 and edge coupler 150 may include corresponding alignment features 164 for attaching FAU 160 to edge coupler 150. Alignment features 164 may include alignment pins configured to be inserted into corresponding recesses. The pins and recesses may be disposed on either or both of edge coupler 150 and FAU 160 in corresponding pairs. Although two pairs are illustrated, it can be appreciated that only one pair or more than two pairs may be used. In some embodiments, alignment features 164 may be configured to align FAU 160 and edge coupler 150 to an alignment accuracy of ±5 μm or less. In some embodiments, index-matching fluid may be used to secure FAU 160 to edge coupler 150.

Although as illustrated, FAU 160 is attached to edge coupler 150 directly, in some embodiments, an interposer may be disposed between FAU 160 and edge coupler 150. The interposer may include optical components (e.g., waveguides, lenses, couplers) for optically coupling waveguide 108 to fiber 162. The interposer may additionally have an optical fiber interface, such as v-grooves or grating couplers, to establish chip-to-chip communication and cryogenic interconnections. The interposer may additionally have electrical components (e.g., traces, vias, pads) for providing an electrical interface.

To facilitate optical coupling of the light beam output by lens 157 to fiber 162, in some embodiments, FAU 160 includes lens 159. Lens 159 may be configured to focus the light collimated by the first lens to fiber 162. As shown in FIG. 1B, spatial profile 138 continues from spatial profile 137 and narrows as it extends from lens 159 to fiber 162. In some embodiments, lens 159 may be configured to provide optical coupling tolerance to misalignment of 5 μm offset in either direction.

FIG. 2 illustrates an example photonic package comprising the photonic device of FIG. 1A, according to some embodiments. As illustrated, the photonic device may be disposed on substrate 100 and may include one or more application-specific integrated circuits (ASICs) 200 disposed on PIC 102. In some embodiments, substrate 100 may comprise an organic substrate attached to, and electrically coupled to PIC 102. For example, substrate 100 may be coupled with through silicon vias (TSVs) 145 and bumps 147 of PIC 102. The region between substrate 100 and PIC 102 may be filled with underfill (e.g., capillary underfill).

ASICs 200 may comprise any suitable electronic integrated circuit (EIC) for performing electronic functions (e.g., memory storage, processing, electronic control of PIC 102, electronic switching components). For example, each ASIC 200 may comprise a memory chip (e.g., high bandwidth memory), a compute chip (e.g., a central processing unit (CPU), a graphics processing unit (GPU), a tensor processing unit (TPU), an accelerator or any other suitable xPU), a switching chip, an input/output (I/O) chip, a serializer/deserializer (SerDes) and/or any other suitable electronic chip component. In some embodiments, ASICs 200 may be electrically coupled to PIC 102 through one or more vias through PIC 102 (e.g., through cladding 111).

In the arrangement of FIG. 2, the entire bottom surface of ASIC 200 is disposed on top of PIC 102. In other embodiments, however, only a portion of an ASIC may be disposed on top of a PIC; the remainder of the bottom surface of the ASIC may extend beyond the outer edge of the PIC. For example, the remainder of the bottom surface of the ASIC may be disposed on a portion of an underfill (or encapsulant) formed next to PIC 102.

FIG. 3 illustrates another example photonic package comprising the photonic device of FIG. 1A, according to some embodiments. The photonic package of FIG. 3 is similar to the photonic package of FIG. 2 in the optical coupling mechanism and its components. However, the photonic package of FIG. 3 may differ in that it is positioned in an opposite orientation than the photonic package of FIG. 2. For example, PIC 102 may be flip-chip bonded to substrate 100.

As with the photonic package of FIG. 2, one or more ASICs may be disposed on PIC 102, where PIC 102 is disposed between substrate 100 and the ASICs (not pictured). Because of the reversed orientation of PIC 102 (with respect to its orientation in the package of FIG. 2), PIC 102 may be ground to reveal the TSVs on a surface of PIC 102 opposite the surface facing substrate 100. In that way, PIC 102 may be electrically coupled with the ASICs through TSVs.

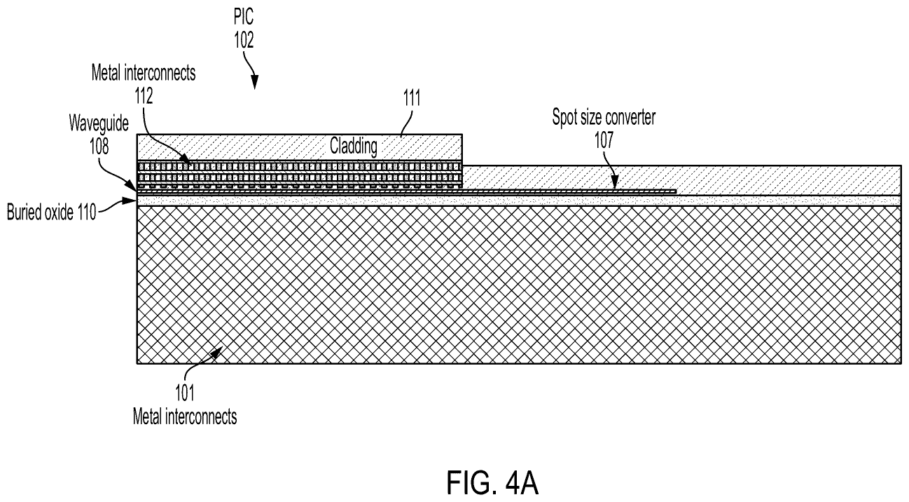

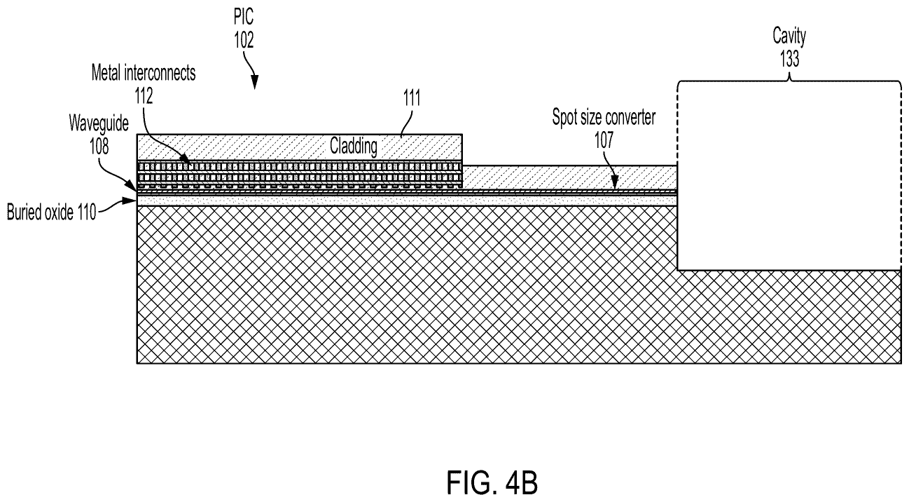

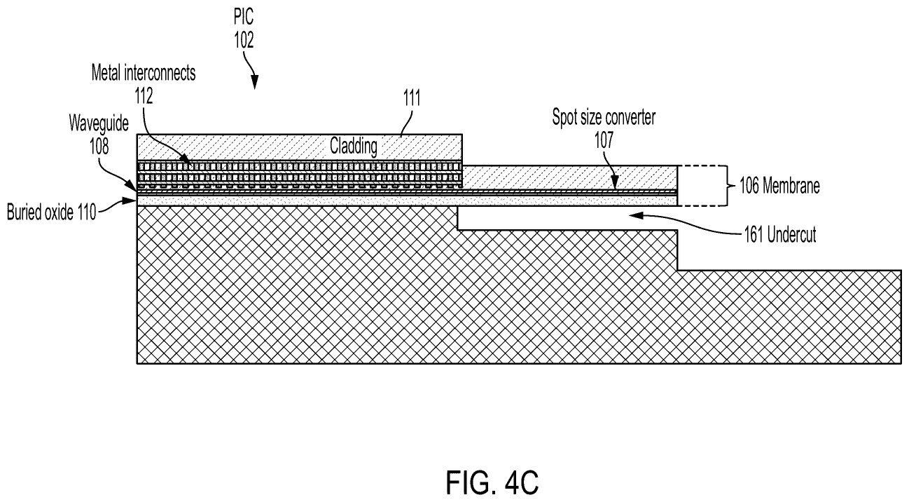

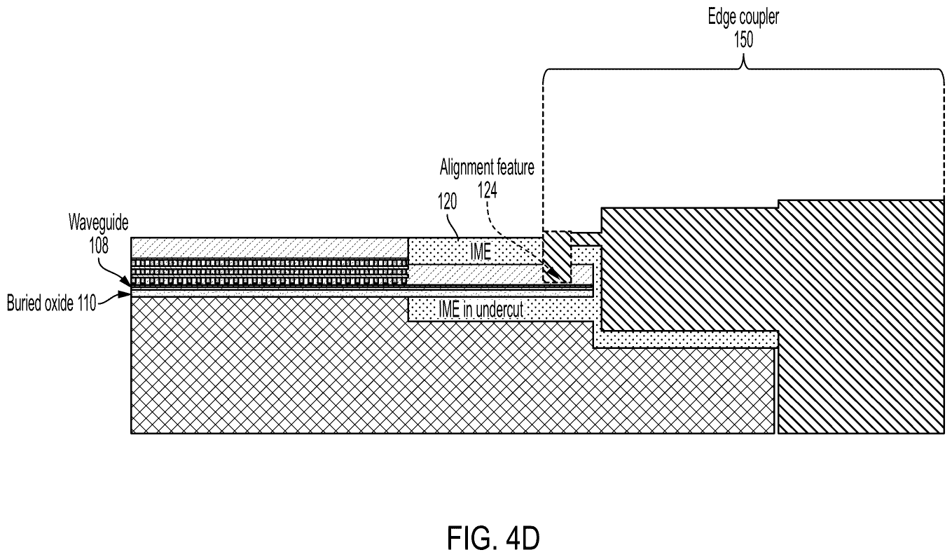

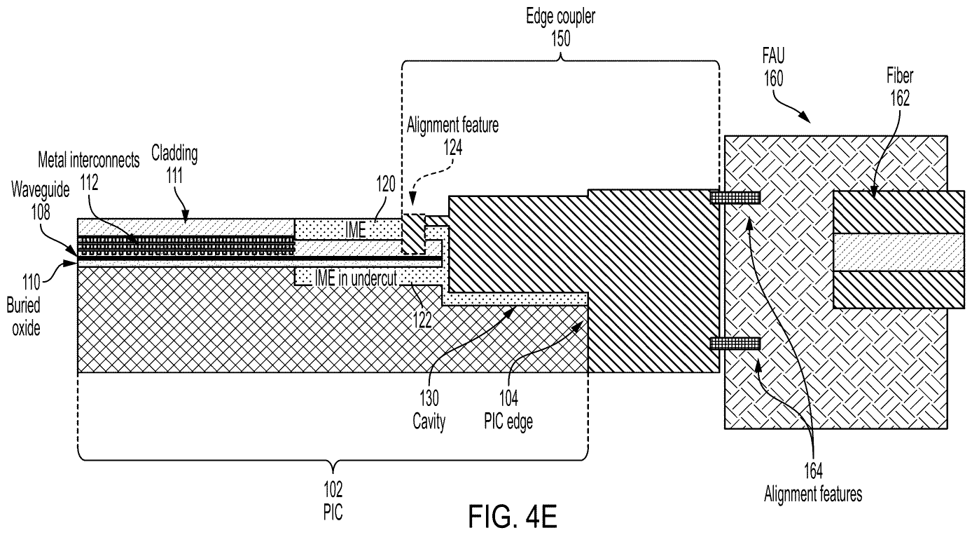

FIGS. 4A-4E illustrate an example method of manufacturing a photonic device, according to some embodiments. The method may begin with obtaining a PIC having a waveguide optically coupled with an SSC. FIG. 4A illustrates an example PIC that may be used to manufacture a photonic device, according to some embodiments. PIC 102 includes a PIC substrate 101, waveguide 108, metal interconnects 112, and cladding 111. Waveguide 108 is optically coupled to SSC 107. For example, in some embodiments, SSC 107 may comprise a tapered portion of waveguide 108. In some embodiments, PIC 102 is obtained from a foundry having the waveguide pre-patterned thereon. Alternatively, in some embodiments, obtaining the PIC may comprise patterning the PIC using in-house techniques including, but not limited to, lithography, laser writing, wet etching, dry etching, or anisotropic etching.

The method then proceeds with etching the PIC to define a cavity in the PIC (e.g., along an edge of the PIC). FIG. 4B illustrates the PIC of FIG. 4A having been etched to define a cavity, according to some embodiments. Cavity 133 may be etched through one or more layers of PIC 102 using any suitable etching technique, for example, wet etching, dry etching, or anisotropic etching. Cavity 133 may be etched partially through PIC 102 from a surface to define the location at which an edge coupler may be coupled with PIC 102. In some embodiments, cavity 133 may extend (e.g., in a direction parallel to the surface) from an edge of PIC 102 towards SSC 107. In some embodiments, cavity 133 may extend from the edge of PIC 102 to expose a coupling end of SSC 107. In that way, when an edge coupler is placed in cavity 133 it may be optically coupled with SSC 107.

Optionally, a membrane may be formed to facilitate optical coupling between the PIC and edge coupler. For example, in some embodiments, further portions of the PIC surrounding waveguide 108 and SSC 107 may be etched to form a membrane comprising at least SSC 107 and cladding 111. FIG. 4C illustrates the PIC of FIG. 4A having been further etched to form a membrane extending towards the cavity, according to some embodiments. To form the membrane 106, undercut 161 is etched from the cavity towards an interior of the PIC. Undercut 161 may be formed in any suitable manner, including for example, dry etching, wet etching, or anisotropic etching. In some embodiments, SSC 107 may define where undercut 161 is formed. For example, undercut 161 may extend the entire length of SSC 107, which may be used as a reference for the etch. Forming undercut 161 may facilitate MFD expansion of SSC 107. For example, as will be discussed further below with respect to FIG. 4D, in some embodiments, IME may be disposed within undercut 161 to facilitate MFD expansion prior to light exiting PIC 102. In some embodiments, to achieve a particular MFD, undercut 161 may have a thickness such that the distance between waveguide 108 and the surface of PIC 101 in undercut 161 is approximately equal to the MFD or greater. In some embodiments, undercut 161 may have a thickness of between 5-10 μm or greater. In some embodiments, undercut 161 may have a thickness of approximately 9 μm or greater. In some embodiments, undercut 161 may have a thickness of approximately 7 μm or greater.

The method then proceeds with disposing an IME in the cavity and securing the edge coupler to the PIC. FIG. 4D illustrates the PIC of FIG. 4A further having index matching epoxy (IME) disposed in the cavity and an edge coupler placed in the cavity, according to some embodiments. The IME 120 may be configured to secure edge coupler 150 to PIC 102. For example, after placing edge coupler 150 in cavity 133, the IME may be cured (e.g., by ultraviolet curing) to secure edge coupler 150 in cavity 133. Further, in some embodiments, the IME 120 may be disposed in undercut 161 and may surround membrane 106. In that way, IME 120 may facilitate MFD expansion of light propagating through SSC 107 by containing the optical mode of the light.

In some embodiments, placing edge coupler 150 in cavity 133 comprises aligning alignment features of edge coupler 150 with corresponding alignment features of PIC 102. In some embodiments, alignment feature 124 may comprise an arm extending from edge coupler 150. When edge coupler 150 is coupled with PIC 102, alignment feature 124 may extend at least partially along SSC 107 or waveguide 108. Alignment feature 124 may be configured to engage with a corresponding recess in PIC 102 to align SSC 107 with the optical components of edge coupler 150, reducing the insertion losses attributable to the SSC-coupler interface. In some embodiments, the corresponding recess in PIC 102 may be formed in membrane 106. In some embodiments, the alignment features facilitate coupling of edge coupler 150 and PIC 102 to an alignment accuracy (e.g., maximum offset) of approximately ±1.5 μm or less.

The method proceeds with attaching a pluggable assembly (e.g., pluggable fiber assembly) to the edge coupler to form an optical path from the waveguide of the PIC to an optical fiber. Attaching pluggable assembly to the edge coupler may comprise mating alignment features in the pluggable assembly with alignment features in the edge coupler. FIG. 4E illustrates the PIC of FIG. 4A further having a pluggable assembly removably attached to the edge coupler, according to some embodiments. The pluggable assembly may be configured to be removably attached to edge coupler 150 so that defective assemblies or photonic devices may be easily identified and replaced.

The pluggable assembly may be configured to be removably attached to edge coupler 150 via alignment features 164 disposed on FAU 160 of the pluggable assembly and corresponding alignment features on edge coupler 150. For example, the alignment features may include alignment pins configured to be pluggable into corresponding alignment recesses. In some embodiments, the alignment features 164 may comprise alignment pins, alignment recesses, or a combination of both. The alignment features may be configured to align the optical components of the pluggable assembly (e.g., lens 159) with optical components of edge coupler 150 (e.g., lens 157) to form an optical path from waveguide 108 to fiber 162. In some embodiments, the alignment features may be configured to align the components with an accuracy of ±5 μm. For example, as discussed above, lens 157 in optical coupler 150 may be configured to collimate light received from PIC 102. Lens 159 in the pluggable assembly may have a diameter 10 μm thicker than the thickness of the collimated beam so that the pluggable assembly may have a 5 μm misalignment tolerance in either direction to minimize any loss attributable to the coupler-assembly interface.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

As used herein, terms such as “above,” “below,” “over,” “under,” “adjacent,” “upper,” “top,” “lower,” “bottom,” “vertical,” “horizontal,” “lateral,” and similar positional or directional descriptors are used solely to describe the relative arrangement and orientation of features as illustrated in the drawings and are not intended to be limiting. Such terms do not require any particular orientation of the device in use, manufacture, or operation, and the described features may be oriented in any direction without departing from the scope of the present disclosure.

Moreover, these terms are not intended to imply any absolute position, gravitational reference, or fixed spatial relationship, and components described as being positioned using positional or directional descriptors may be arranged in different relative positions, including inverted, rotated, or otherwise reoriented configurations, while still performing the same function in substantially the same way to achieve substantially the same result.

What is claimed is:

1. A photonic device, comprising:
a photonic integrated circuit (PIC) having a waveguide and a membrane comprising a spot size converter (SSC) optically coupled to the waveguide, wherein the PIC defines a cavity positioned at an edge of the PIC;
an edge coupler disposed at least partially in the cavity of the PIC; and
a pluggable assembly comprising a fiber array unit (FAU) and a fiber attached to the FAU, wherein the FAU is attached to the edge coupler, and wherein the edge coupler defines an optical path optically coupling the SSC to the fiber.

2. The photonic device of claim 1, wherein the edge coupler comprises a first lens configured to collimate light emitted by the SSC.

3. The photonic device of claim 2, wherein the pluggable assembly comprises a second lens configured to focus the light collimated by the first lens to the fiber.

4. The photonic device of claim 2, wherein the first lens is configured to collimate the light emitted by the SSC to a mode field diameter (MFD) between 20 μm and 30 μm.

5. The photonic device of claim 1, wherein the SSC is configured to spatially expand light received from the waveguide to a first MFD between 5 μm and 15 μm as the light exits the PIC.

6. The photonic device of claim 5, wherein the edge coupler is configured to further spatially expand the light from the first MFD to a second MFD between 20 μm and 30 μm as the light exits the edge coupler.

7. The photonic device of claim 1, further comprising an index matching epoxy (IME) disposed between a substrate of the PIC and the membrane.

8. The photonic device of claim 7, wherein the IME extends in the cavity between the substrate of the PIC and the edge coupler.

9. A photonic device, comprising:
a photonic integrated circuit (PIC) having a waveguide optically coupled with a spot-size converter (SSC), wherein the PIC defines a cavity positioned at an edge of the PIC;
an edge coupler disposed at least partially in the cavity of the PIC, the edge coupler comprising a first lens configured to collimate light emitted by the SSC; and
a pluggable assembly comprising a fiber array unit (FAU) and a fiber attached to the FAU, wherein the FAU is attached to the edge coupler, and wherein the edge coupler defines an optical path optically coupling the SSC to the fiber.

10. The photonic device of claim 9, wherein the pluggable assembly comprises a second lens configured to focus the light collimated by the first lens on the fiber.

11. The photonic device of claim 9, further comprising an undercut extending from the cavity on an interior side of the SSC.

12. The photonic device of claim 11, further comprising an IME disposed in the cavity between a substrate of the PIC and the waveguide.

13. The photonic device of claim 12, wherein the IME extends in the cavity between the substrate of the PIC and the edge coupler.

14. The photonic device of claim 9, wherein the SSC is configured to spatially expand light received from the waveguide to a first mode field diameter between 5 μm and 15 μm as the light exits the PIC.

15. The photonic device of claim 9, wherein the edge coupler is configured to further spatially expand the light from a first mode field diameter to a second mode field diameter between 20 μm and 30 μm as the light exits the edge coupler.

16. A method of manufacturing a photonic device, the method comprising:
obtaining a photonic integrated circuit (PIC) having a waveguide optically coupled with an SSC;
etching a portion of a substrate of the PIC to define a cavity at an edge of the PIC;
placing an edge coupler in the cavity, the edge coupler having a first lens configured to collimate light received from the waveguide; and
removably attaching a pluggable assembly, comprising an FAU and a fiber attached to the FAU to the edge coupler, to the edge coupler, so that the edge coupler defines an optical path optically coupling the SSC to the fiber.

17. The method of claim 16, further comprising, prior to placing the edge coupler in the cavity, forming a membrane comprising the SSC by etching a portion of the substrate from the cavity to an interior of the PIC in correspondence with the SSC.

18. The method of claim 17, further comprising filling a volume between the substrate and the membrane.

19. The method of claim 16, further comprising, prior to placing the edge coupler in the cavity, disposing IME in the cavity and wherein:
placing the edge coupler in the cavity comprises placing the edge coupler so it abuts the IME in the cavity.

20. The method of claim 16, wherein removably attaching the pluggable assembly to the edge coupler comprises mating alignment features in the pluggable assembly with alignment features in the edge coupler.
